(19) United States
(12) Patent Application Publication
(10) Pub. No.: US 2008/0191691 A1
(43) Pub. Date: Aug. 14, 2008

(54) Magnetic encoder assembly

(76) Inventors: Thomas A. Baudendistel, Farmersville, OH (US); Melinda D. Simpson, Jamestown, OH (US); Alan H. Green, Germantown, OH (US); Jerold L. Barlage, Russia, OH (US)

Correspondence Address: DELPHI TECHNOLOGIES, INC., M/C 480-410-202, PO BOX 5052, TROY, MI, 48007, US

(21) Appl. No.: 11/706,092

(22) Filed: Feb. 13, 2007

(51) Int. Cl. G01B 7/30

(52) U.S. Cl. 324/207.25; 324/207.2

(57) ABSTRACT

A first magnetic encoder assembly includes a magnetic encoder ring. The magnetic encoder ring has a circumferential surface and a magnetic field. The magnetic field has a direction which substantially continuously varies in angle as one travels along the circumferential surface. A second magnetic encoder assembly includes a substantially-linearly-extending magnetic encoder strip. The magnetic encoder strip has a magnetic working length and a magnetic field. The magnetic field has a direction which substantially continuously varies in angle as one travels along the magnetic working length.

### TECHNICAL FIELD

The present invention relates generally to encoders, and more particularly to a magnetic encoder assembly.

### BACKGROUND OF THE INVENTION

Conventional magnetic encoder assemblies are known including those having a magnetic encoder ring which surrounds and is attached to a wheel axle or wheel bearing of a vehicle and having an “on/off” Hall effect sensor which is attached to a wheel knuckle of the vehicle. The circumferential surface of the magnetic encoder ring has a fully circumferential array of alternating north and south magnetic poles (aligned parallel to the longitudinal axis of the ring) whose rotating passage by the Hall effect sensor is sensed as a square wave voltage output having an “on” value when one pole is sensed and having an “off” value when an opposite pole is sensed. The vehicle's electronic control unit (ECU) determines the wheel speed of the vehicle from the frequency of the square wave, as is known to those skilled in the art. The determined wheel speed is used by one or more systems of the vehicle such as the vehicle's anti-lock braking system (ABS). Due to the digital nature of the sensor output, there is an inherent bandwidth limit to the resolution of the sensor output. This limit creates problems when trying to accurately determine a low wheel speed including not sensing movement “within a pole” and sensing a false speed during dithering at a pole interface.

Conventional magnetic encoder assemblies also are known which include a linear magnetic encoder strip and an “on/off” Hall effect sensor wherein the strip has a linearly extending array of alternating north and south magnetic poles (aligned perpendicular to the longitudinal axis of the strip). When the magnetic encoder strip moves linearly past the Hall effect sensor (or the Hall effect sensor moves linearly along the magnetic encoder strip, the speed of such relative movement can be determined from the frequency of the square wave voltage output of the Hall effect sensor.

What is needed is an improved magnetic encoder assembly.

### SUMMARY OF THE INVENTION

A first expression of a first embodiment of the invention is for a magnetic encoder assembly including a magnetic encoder ring. The magnetic encoder ring has a circumferential surface and a magnetic field. The magnetic field has a direction which substantially continuously varies in angle as one travels along the circumferential surface.

A second expression of a first embodiment of the invention is for a magnetic encoder assembly including a magnetic encoder ring. The magnetic encoder ring has a circumferential surface and a magnetic field. The magnetic field has a direction which substantially continuously varies in angle as one travels along the circumferential surface. The magnetic encoder ring rotates with and is directly or indirectly attached to a vehicle tire-supporting wheel. The circumferential surface has a fully circumferential array of circumferentially adjacent magnetic poles. Adjacent poles have different magnetic North directions. Adjacent poles do not have opposite magnetic North directions.

A first expression of a second embodiment of the invention is for a magnetic encoder assembly including a substantially-linearly-extending magnetic encoder strip. The magnetic encoder strip has a magnetic working length and a magnetic field. The magnetic field has a direction which substantially continuously varies in angle as one travels along the magnetic working length.

Several benefits and advantages are derived from one or more of the expressions of embodiments of the invention. In one enablement, the magnetic encoder assembly includes other components and functions as a dual resolution wheel speed sensor. In one example, a rotary Hall effect sensor has a voltage output corresponding to the angle of the magnetic field of the magnetic encoder disk. In this example, a digital signal processor is used to calculate wheel speed from the voltage output. In this example, at low wheel speeds the voltage output passes through an analog-to-digital converter before reaching the digital signal processor, and at high wheel speeds the voltage output passes through a saturated gain amplifier before reaching the processor. Applicants believe that a magnetic encoder assembly, when so constructed, should provide for increased resolution at low wheel speeds without increased resolution at high wheel speeds. It is noted that increased resolution at high wheel speeds would require a relatively expensive processor.

### SUMMARY OF THE DRAWINGS

FIG. 1 is a diagram of a first embodiment of a magnetic encoder assembly including a magnetic encoder ring and a rotary Hall effect sensor shown in perspective and including an analog-to-digital converter, a saturated gain amplifier, and a digital signal processor shown schematically;

FIG. 2 is a schematic side-elevational view of an embodiment of the magnetic encoder ring and the rotary Hall effect sensor of FIG. 1, wherein an arrow indicating the magnetic North direction has been drawn on each magnetic pole and wherein four radii have been drawn which will intersect the corresponding magnetic North directions of four magnetic poles;

FIG. 3 is a graph of the angle (represented by the y axis) of direction of the magnetic field of the magnetic encoder ring of FIG. 1 versus rotary (circumferential) distance (represented by the x axis) along the magnetic ring of FIG. 1;

FIG. 4 is a graph of the output (represented by the y axis) of the rotary Hall effect sensor of FIG. 1 versus rotary distance (represented by the x axis) along the magnetic encoder ring of FIG. 1;

FIG. 5 is a graph of the output (represented by the y axis) of the saturated gain amplifier of FIG. 1 versus rotary distance (represented by the x axis) along the magnetic encoder ring of FIG. 1;

FIG. 6 is a schematic side-elevational view of an alternate embodiment of a magnetic encoder ring and a rotary Hall sensor;

FIG. 7 is a view taken along lines 7-7 of FIG. 6, wherein an arrow indicating the magnetic North direction has been drawn on each magnetic pole;

FIG. 8 is a diagram of a second embodiment of a magnetic encoder assembly including a substantially-linearly-extending magnetic encoder strip and including a rotary Hall effect sensor; and

FIGS. 9 and 10 show alternate magnetic pole arrangements.

### DETAILED DESCRIPTION

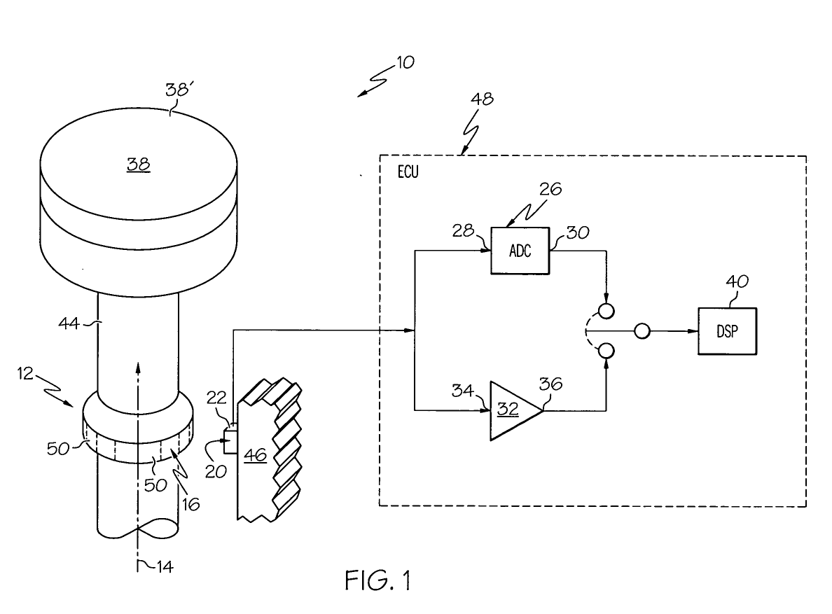

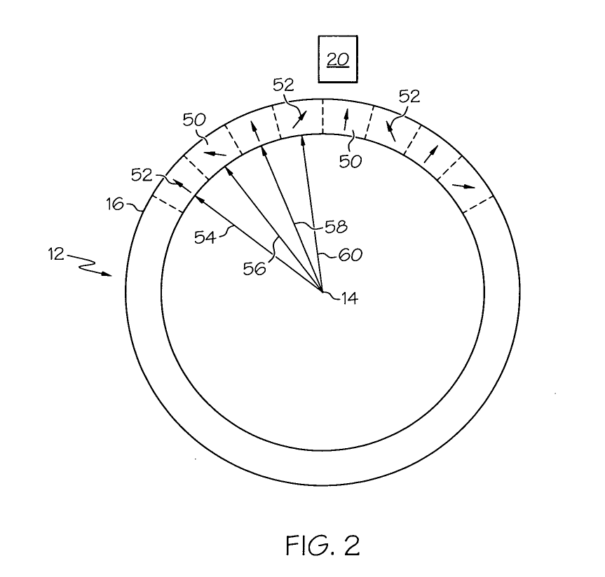

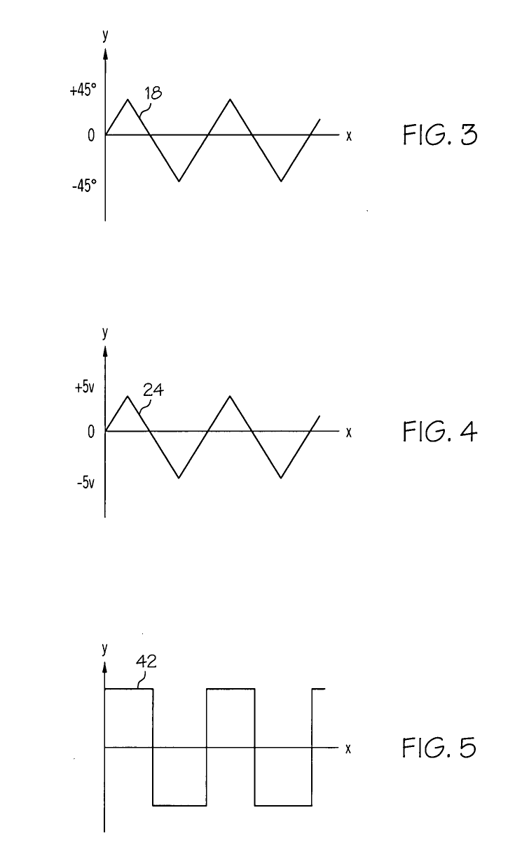

A first embodiment of a magnetic encoder assembly 10 is shown in FIGS. 1-2 with explanatory graphs shown in FIGS. 3-5. A first expression of the embodiment of FIGS. 1-2 is for a magnetic encoder assembly 10 including a magnetic encoder ring 12 having a circumferential surface 16 and a magnetic field, wherein the magnetic field has a direction which substantially continuously varies in angle 18 as one travels along the circumferential surface 16.

The circumferential surface 16 faces substantially radially outward from a longitudinal axis 14 of the magnetic encoder ring 12. The longitudinal axis 14 is a central longitudinal axis. By “traveling along” the circumferential surface 16 is meant traveling circumferentially along the circumferential surface 16. A “directional longitudinal axis” is a longitudinal axis having one end considered to point along a zero degrees direction for reference purposes.

It is noted that FIG. 3 shows an example of the angle 18 of the direction of the magnetic field which can be said to be substantially continuously varying as one travels along the circumferential surface 16 despite possible discontinuous changes in slope occurring at discrete “points” having negligible length along the circumferential surface 16.

In one implementation of the first expression of the embodiment of FIGS. 1-2, the magnetic encoder assembly 10 also includes a rotary Hall effect sensor 20 disposed proximate the circumferential surface 16 to sense the magnetic field, wherein the rotary Hall effect sensor 20 has an output 22 having an output signal 24 which corresponds to the angle 18 of the sensed magnetic field of the magnetic encoder ring 12. In one example, the rotary Hall effect sensor 20 is rotary Hall effect sensor MLX90316 supplied by Melexis Microelectronic Systems whose address is 41 Locke Road, Concord, N.H. 03301. It is noted that if the magnetic field rotates, in plane, 360 degrees about the z-axis of the MLX90316 chip, the chip will output the full scale, representing 0 through 360 degrees. It is also noted that the rotary Hall effect sensor 20 itself does not rotate (e.g., the MLX90316 chip itself does not rotate).

In one variation of the implementation, the magnetic encoder assembly 10 also includes an analog-to-digital converter (ADC) 26 having an input 28 and an output 30 and includes a saturated gain amplifier 32 having an input 34 and an output 36, wherein the input 28 of the analog-to-digital converter 26 and the input 34 of the saturated gain amplifier 32 are connected in parallel to the output 22 of the rotary Hall effect sensor 20. It is noted that the saturated gain amplifier 32 saturates to a positive number every time the output signal 24 of the rotary Hall effect sensor 20 goes positive and saturates to a negative number every time the output signal 24 of the rotary Hall effect sensor 20 goes negative. In one modification, the magnetic encoder ring 12 rotates with and is directly or indirectly attached to a wheel 38, and the magnetic encoder assembly 10 also includes a digital signal processor (DSP) 40 which is operatively connected to the output 30 of the analog-to-digital converter 26 to calculate a wheel speed of the wheel 38 when a previously calculated wheel speed was below a predetermined speed. In the same modification, the digital signal processor 40 is operatively connected to the output 36 of the saturated gain amplifier 32 to calculate the wheel speed when the previously calculated wheel speed was at or above the predetermined speed. It is noted that the saturated gain amplifier 32 converts the triangle output signal 24 (shown in FIG. 4) of the rotary Hall effect sensor 20 to a square wave output signal 42 (shown in FIG. 5) and that the saturated gain amplifier 32 may be replaced with a different component adapted to perform the same signal conversion.

In one application of the implementation, the wheel 38 is a vehicle tire-supporting wheel 38′. In one example, the magnetic encoder ring 12 rotates with and is attached to a wheel axle 44 or a wheel bearing. In the same application, the rotary Hall effect sensor 20 is attached to a vehicle component 46 which does not rotate with the vehicle tire-supporting wheel 38′.In one example, the rotary Hall effect sensor 20 is attached to a wheel knuckle. In one employment, the analog-to-digital converter 26, the saturated gain amplifier 32, and the digital signal processor 40 are components of a vehicle electronic control unit (ECU) 48.

In the same or a different implementation, the circumferential surface 16 has a fully circumferential array of circumferentially adjacent magnetic poles 50, wherein adjacent poles 50 have different magnetic North directions 52, and wherein adjacent poles 50 do not have opposite magnetic North directions 52. In one arrangement, the magnetic North directions 52, when viewed looking at the circumferential surface 16 from a side of the magnetic encoder ring, are a repeating sequential pattern of a first direction which is substantially a same angular direction as a radius 54 which will intersect the first direction, a second direction which is rotated less than ninety degrees counterclockwise from a radius 56 which will intersect the second direction, a third direction which is substantially a same angular direction as a radius 58 which will intersect the third direction, and a fourth direction which is rotated less than ninety degrees clockwise from a radius which will intersect the fourth direction (as shown in FIG. 2). In one configuration, the second direction is substantially forty-five degrees and the fourth direction is substantially forty-five degrees.

In one enablement, there are 7 degrees between the adjacent magnetic poles 50 of the circumferential surface 16 of the magnetic encoder ring 12. This would mean that the angle 18 of the direction of the magnetic field of FIG. 3 would linearly change from +45 degrees (+45°) to −45 degrees (−45°) over a corresponding 7 degree rotation (e.g., a 7 degree rotary distance along the x axis in FIG. 3) of the magnetic encoder ring 12 past the rotary Hall effect sensor 20. This would mean that the output signal 24 of the rotary Hall effect sensor 20 of FIG. 4 would linearly change from +5 volts (+5 v) to −5 volts (−5 v) for the 7 degree rotation (i.e., the 7 degree rotary distance along the x axis in FIG. 4) of the magnetic encoder ring 12. Other values for the degrees and volts may be chosen by the artisan. This linear change is reflected in the output signal 30 of the analog-to-digital converter 26 and could be used as a high resolution wheel speed sensor for low wheel speeds and processed by the digital signal processor 40 to yield the wheel speed, as is within the ordinary level of skill of the artisan. However, the amount of this data and the speed of this data would quickly over-run a relatively inexpensive digital signal processor at high wheel speeds. Thus, the frequency of the square wave output signal 42 of the output 36 of the saturated gain amplifier 32 could be used as a low resolution wheel speed sensor for high wheel speeds and processed by the digital signal processor 40 (which can be a relatively inexpensive digital signal processor) to yield the wheel speed, as is within the ordinary level of skill of the artisan.

In one method of making the magnetic encoder ring 12, each magnetic pole 50 of the circumferential surface 16 of the magnetic encoder ring 12 is an attached individual magnet having a magnetic North direction 52. In another method of making, one or more magnetizing coils are used to magnetize circumferential zones of the circumferential surface 16 to create the magnetic poles 50 with a desired repeating pattern of magnetic North directions 52. In one example, magnetic poles 50 having a linearized rotary (circumferential) width as small as one-sixteenth of an inch are created.

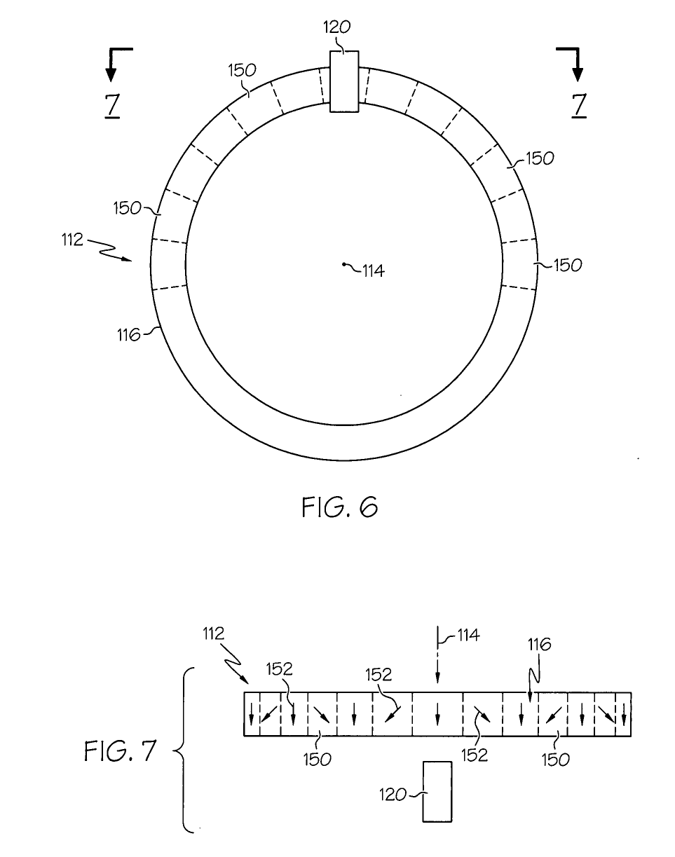

An alternate embodiment of a magnetic encoder ring 112 and a rotary Hall effect sensor 120 is shown in FIGS. 6 and 7. The magnetic encoder ring 112 has a directional longitudinal axis 114. The magnetic North directions 152 of the magnetic poles 150 of the circumferential surface 116 of the magnetic encoder ring 112, when viewed looking on the circumferential surface 116, are a repeating sequential pattern of a first direction which is substantially a same angular direction as the longitudinal axis 114, a second direction which is rotated less than ninety degrees counterclockwise from the longitudinal axis 114, a third direction which is substantially a same angular direction as the longitudinal axis 114, and a fourth direction which is rotated less than ninety degrees clockwise from the longitudinal axis 114 (as shown in FIG. 7). In one configuration, the second direction is substantially forty-five degrees and the fourth direction is substantially forty-five degrees.

A second expression of the embodiment of FIGS. 1-2 is for a magnetic encoder assembly 10 including a magnetic encoder ring 12. The magnetic encoder ring 12 a circumferential surface 16 and a magnetic field. The magnetic field has a direction which substantially continuously varies in angle 18 as one travels along the circumferential surface 16. The magnetic encoder ring 12 rotates with and is directly or indirectly attached to a vehicle tire-supporting wheel 38′.The circumferential surface 16 has a fully circumferential array of circumferentially adjacent magnetic poles 50. Adjacent poles 50 have different magnetic North directions 52.

A second embodiment of a magnetic encoder assembly 210 is shown in FIG. 8. A first expression of the embodiment of FIG. 8 is for a magnetic encoder assembly 210 including a substantially-linearly-extending magnetic encoder strip 212. The magnetic encoder strip 212 has a magnetic working length and a magnetic field. The magnetic field has a direction which substantially continuously varies in angle as one travels along the magnetic working length.

A magnetic working length is a strip length for which the magnetic field has a direction which substantially continuously varies in angle as one travels along such strip length.

In one implementation of the first expression of the embodiment of FIG. 8, the magnetic encoder assembly 210 also includes a rotary Hall effect sensor 220 disposed proximate the magnetic encoder strip 212 to sense the magnetic field, wherein the rotary Hall effect sensor 220 has an output 222 having an output signal (similar to output signal 24 of FIG. 4) which corresponds to the angle (similar to angle 18 of FIG. 3) of the sensed magnetic field of the magnetic encoder strip 212. In one example, the un-numbered arrowed signal line leading from the output 222 of the rotary Hall effect sensor 220 is operatively connected to a vehicle electronic control unit.

In the same or a different implementation, the magnetic working length has a substantially-linearly-extending array of longitudinally adjacent magnetic poles 250, wherein adjacent poles 250 have different magnetic North directions 252, and wherein adjacent poles 250 do not have opposite magnetic North directions 252. In one arrangement, the magnetic encoder ring 212 has a directional transverse axis 214. In this arrangement, the magnetic North directions 252, when viewed looking down on the magnetic encoder strip 212, are a repeating sequential pattern of a direction which is substantially a same angular direction as the transverse axis 214, a direction which is rotated less than ninety degrees counterclockwise from the transverse axis 214, a direction which is substantially a same angular direction as the transverse axis 214, and a direction which is rotated less than ninety degrees clockwise from the transverse axis 214 (as shown in FIG. 8). In one configuration, the second direction is substantially forty-five degrees and the fourth direction is substantially forty-five degrees.

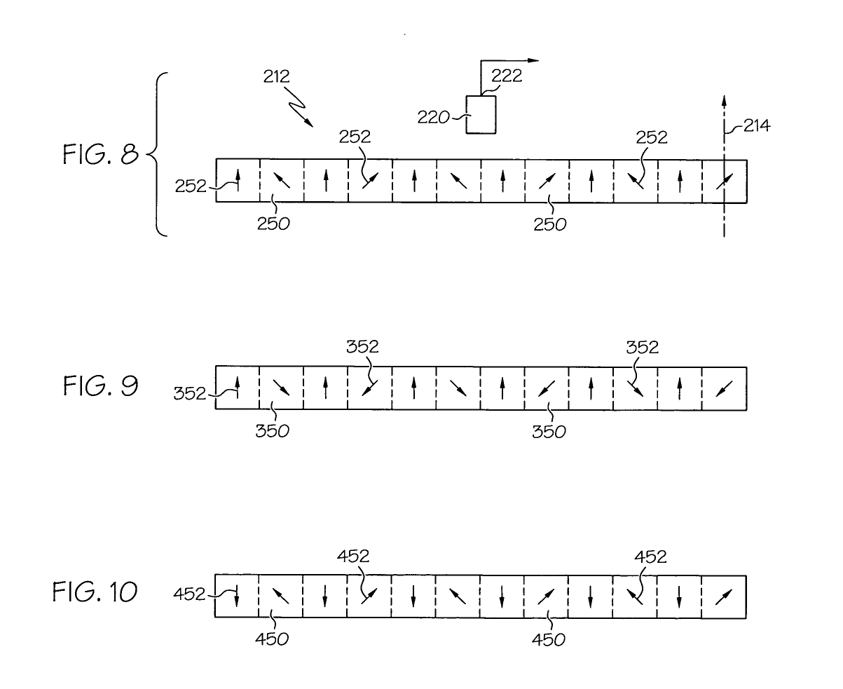

Alternate magnetic pole arrangements are shown in FIGS. 9 and 10. In FIG. 9. the arrangement of the magnetic North directions 352 of the magnetic poles 350 can be substituted for the arrangement shown in FIG. 7 and/or FIG. 8. Likewise, in FIG. 10, the arrangement of the magnetic North directions 452 of the magnetic poles 450 can be substituted for the arrangement shown in FIG. 7 and/or FIG. 8.

Several benefits and advantages are derived from one or more of the expressions of embodiments of the invention. In one enablement, the magnetic encoder assembly includes other components and functions as a dual resolution wheel speed sensor. In one example, a rotary Hall effect sensor has a voltage output corresponding to the angle of the magnetic field of the magnetic encoder disk. In this example, a digital signal processor is used to calculate wheel speed from the voltage output. In this example, at low wheel speeds the voltage output passes through an analog-to-digital converter before reaching the digital signal processor, and at high wheel speeds the voltage output passes through a saturated gain amplifier before reaching the processor. Applicants believe that a magnetic encoder assembly, when so constructed, should provide for increased resolution at low wheel speeds without increased resolution at high wheel speeds. It is noted that increased resolution at high wheel speeds would require a relatively expensive processor.

The foregoing description of several expressions of embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

1. A magnetic encoder assembly comprising a magnetic encoder ring having a circumferential surface and a magnetic field, wherein the magnetic field has a direction which substantially continuously varies in angle as one travels along the circumferential surface.

2. The magnetic encoder assembly of claim 1, also including a rotary Hall effect sensor disposed proximate the circumferential surface to sense the magnetic field, wherein the rotary Hall effect sensor has an output having an output signal which corresponds to the angle of the sensed magnetic field of the magnetic encoder ring.

3. The magnetic encoder assembly of claim 2, also including an analog-to-digital converter having an input and an output and including a saturated gain amplifier having an input and an output, wherein the input of the analog-to-digital converter and the input of the saturated gain amplifier are connected in parallel to the output of the rotary Hall effect sensor.

4. The magnetic encoder assembly of claim 3, wherein the magnetic encoder ring rotates with and is directly or indirectly attached to a wheel, and also including a digital signal processor which is operatively connected to the output of the analog-to-digital converter to calculate a wheel speed of the wheel when a previously calculated wheel speed was below a predetermined speed.

5. The magnetic encoder assembly of claim 4, wherein the digital signal processor is operatively connected to the output of the saturated gain amplifier to calculate the wheel speed when the previously calculated wheel speed was at or above the predetermined speed.

6. The magnetic encoder assembly of claim 5, wherein the wheel is a vehicle tire-supporting wheel.

7. The magnetic encoder assembly of claim 6, wherein the rotary Hall effect sensor is attached to a vehicle component which does not rotate with the vehicle wheel.

8. The magnetic encoder assembly of claim 7, wherein the analog-to-digital converter, the saturated gain amplifier, and the digital signal processor are components of a vehicle electronic control unit.

9. The magnetic encoder assembly of claim 8, wherein the circumferential surface has a fully circumferential array of circumferentially adjacent magnetic poles, wherein adjacent poles have different magnetic North directions, and wherein adjacent poles do not have opposite magnetic North directions.

10. The magnetic encoder assembly of claim 9, wherein the magnetic North directions, when viewed looking at the circumferential surface from a side of the magnetic encoder ring, are a repeating sequential pattern of a first direction which is substantially a same angular direction as a radius which will intersect the first direction, a second direction which is rotated less than ninety degrees counterclockwise from a radius which will intersect the second direction, a third direction which is substantially a same angular direction as a radius which will intersect the third direction, and a fourth direction which is rotated less than ninety degrees clockwise from a radius which will intersect the fourth direction.

11. The magnetic encoder assembly of claim 10, wherein the second direction is substantially forty-five degrees and wherein the fourth direction is substantially forty-five degrees.

12. The magnetic encoder assembly of claim 9, wherein the magnetic encoder ring has a directional longitudinal axis, wherein the magnetic North directions, when viewed looking on the circumferential surface, are a repeating sequential pattern of a first direction which is substantially a same angular direction as the longitudinal axis, a second direction which is rotated less than ninety degrees counterclockwise from the longitudinal axis, a third direction which is substantially a same angular direction as the longitudinal axis, and a fourth direction which is rotated less than ninety degrees clockwise from the longitudinal axis.

13. The magnetic encoder assembly of claim 12, wherein the second direction is substantially forty-five degrees and wherein the fourth direction is substantially forty-five degrees.

14. The magnetic encoder assembly of claim 1, wherein the circumferential surface has a fully circumferential array of circumferentially adjacent magnetic poles, wherein adjacent poles have different magnetic North directions, and wherein adjacent poles do not have opposite magnetic North directions.

15. A magnetic encoder assembly comprising a magnetic encoder ring having a circumferential surface and a magnetic field,
wherein the magnetic field has a direction which substantially continuously varies in angle as one travels along the circumferential surface,
wherein the magnetic encoder ring rotates with and is directly or indirectly attached to a vehicle tire-supporting wheel,
wherein the circumferential surface has a fully circumferential array of circumferentially adjacent magnetic poles, and
wherein adjacent poles have different magnetic North directions.

16. A magnetic encoder assembly comprising a substantially-linearly-extending magnetic encoder strip a magnetic working length and a magnetic field, wherein the magnetic field has a direction which substantially continuously varies in angle as one travels along the magnetic working length.

17. The magnetic encoder assembly of claim 16, also including a rotary Hall effect sensor disposed proximate the magnetic encoder strip to sense the magnetic field, wherein the rotary Hall effect sensor has an output having an output signal which corresponds to the angle of the sensed magnetic field of the magnetic encoder strip.

18. The magnetic encoder assembly of claim 16 wherein the magnetic working length has a substantially-linearly-extending array of longitudinally adjacent magnetic poles, wherein adjacent poles have different magnetic North directions, and wherein adjacent poles do not have opposite magnetic North directions.

19. The magnetic encoder assembly of claim 18, wherein the magnetic encoder ring has a directional transverse axis, wherein the magnetic North directions, when viewed looking down on the magnetic encoder strip, are a repeating sequential pattern of a first direction which is substantially a same angular direction as the transverse axis, a second direction which is rotated less than ninety degrees counterclockwise from the transverse axis, a third direction which is substantially a same angular direction as the transverse axis, and a fourth direction which is rotated less than ninety degrees clockwise from the transverse axis.

20. The magnetic encoder assembly of claim 19, wherein the second direction is substantially forty-five degrees and wherein the fourth direction is substantially forty-five degrees.
